(19) United States
(12) Patent Application Publication
(10) Pub. No.: US 2006/0064323 A1
(43) Pub. Date: Mar. 23, 2006

(54) Data management center for patient monitoring

(76) Inventors: Todd D. Alleckson, Auburn, CA (US); Energy Cruse II, Foster City, CA (US); Karyn Grant, Sudbury, MA (US); Robert C. Leichner, Menlo Park, CA (US); Gaurang C. Mehta, Union City, CA (US); James M. Rueter, Mountain View, CA (US); Thomas A. Shoup, Los Altos, CA (US); Alexander L. Tudor, Mountain View, CA (US); Ronald T. Yamada, Belmont, CA (US)

Correspondence Address: PHILIPS INTELLECTUAL PROPERTY & STANDARDS, 595 MINER ROAD, CLEVELAND, OH, 44143, US

(21) Appl. No.: 11/263,311

(22) Filed: Oct. 31, 2005

Related U.S. Application Data
(63) Continuation of application No. 09/290,149, filed on Apr. 12, 1999, now abandoned.

(51) Int. Cl. G06Q 10/00; G06Q 99/00

(52) U.S. Cl. 705/2; 705/1

(57) ABSTRACT

A system for providing users access to information of health parameters on patients. The system includes a modem for receiving digital data from one or more patient sources on the health parameters of the patients and a management computer. The management computer processes the digital data and provides clinical statistics and administrative statistics derived from the digital data. Such clinical statistics and administrative statistics can be accessed via Internet protocol by one or more users such that these users each can access the clinical statistics and the administrative statistics independently.

### FIELD OF THE INVENTION

The present invention is related to techniques for capturing a patient's health parameter data and more particularly related to techniques for the automated capture of patient measurements taken in a nonclinical environment and reporting to a remote health management center.

### BACKGROUND

In many countries, e.g., the United States, the general population is getting older on the average. A phenomenon that occurs with an aging population is more long-term ailments that impair the normal physiological functions of a person. In many cases such chronic health problems are not immediately life-threatening to a patient and the patient may not benefit significantly from hospitalization. However, often it is necessary to monitor the day-to-day health conditions of a patient for clinicians to provide adequate care to such an individual. Management of chronic illnesses poses unprecedented challenges to the existing healthcare structure and the delivery of its services. Heart failure, coronary heart disease, unstable angina, heart rhythm disturbances, hypertension, diabetes, asthma, congestive obstructive pulmonary disease, and depression are examples of ailments that need diligent patient contact and measurements in order to institute timely management of the patient's problems before they develop into an untoward clinical course requiring more intensive and expensive management, including hospitalization. For example, for health maintenance, a patient with a risk or history of congested heart failure may need to monitor regularly his weight, blood pressure, temperature, and blood sugar and report the data to a clinic.

For the reason of convenience, if practicable, it is often preferable for a patient to make health parameter measurements. It is advantageous in allowing patients to perform such measurements and report the data to the clinician. To this end, health monitoring systems need to be developed to provide such measurement and reporting functions. In the past, health monitoring required patients to take these measurements manually and report the results either by telephone or by recording them on paper. The human involvement in this process results in the potential for error in reporting the measurement data. Also, significant effort is required to record and manage the patient data by the clinician. Cost effective, secure and confidential remote connections between patients and their clinicians can help to prevent serious, episodic, expensive clinical courses and provide a better quality of life for remotely managed patients.

Because clinicians rely on the data to diagnose and advise the patients, the system should present the necessary health data information in a easily understandable format. Also, it will be beneficial for the system to be versatile so as to provide patient information to a variety of related professionals. For example, patients that need attention and follow up need to be flagged using limits for each patient previously provided by the patient's clinician. Individual patient review of measurements provided in a unified view may be needed to provide dependable patient management.

Furthermore, the system should be reliable. A system that fails to report data when measurements are taken or fails to receive the transmitted data when the data are communicated from the measurement device will compromise the effectiveness of a program that monitors the health and well-being of the patient.

Although both the clinician and the patient may have the desire to monitor the health parameters of the patient consistently, the patient, being impaired physically, may find it a challenge to perform measurement procedures. Therefore, a system that is complex and requires extensive deftness and multiple steps of manipulation to operate will discourage the patient from complying with a monitoring program prescribed by the clinician. There is a need for a health monitoring system that is easy to use.

Techniques and systems for remote monitoring and reporting have been described in the literature. Examples include U.S. Pat. No. 4,803,625 (Fu et al.); U.S. Pat. No. 5,142,484 (Kaufman et al.); U.S. Pat. No. 5,265,010 (Evans-Paganelli et al.); U.S. Pat. No. 5,331,549 (Crawford); U.S. Pat. No. 5,357,427 (Langen et al.); U.S. Pat. No. 5,404,292 (Hendrickson); U.S. Pat. No. 5,558,638 (Evers et al.); U.S. Pat. No. 5,576,952 (Stutman et al); U.S. Pat. No. 5,626,144 (Tracklind et al.); U.S. Pat. No. 5,704,366 (Tracklind et al.); U.S. Pat. No. 5,732,709 (Tracklind et al.); and U.S. Pat. No. 5,832,448 (Brown). Many systems reported in the literature suffers from the lack of reliability, convenience, and flexibility. For example, some systems may fail to report when a measurement unit fails to function properly. Some systems are cumbersome for the patient to use. Yet some systems do not provide the flexibility of data reporting and review/administration needed by health care professionals. There continues to be a need not only for a reliable and flexible measuring and reporting system, but also for remote data management that can efficiently provide information for users such as clinicians to review for clinical and administrative purposes.

### SUMMARY

The present invention provides a technique for managing information gathered on health parameters of patients. In one aspect, the present invention provides a system for providing users access to information of health parameters on patients. The system includes a modem for receiving digital data from one or more patient sources on the health parameters of the patients and a management computer. The management computer processes the digital data to provide clinical statistics and administrative statistics. It also provides access to the clinical statistics and administrative statistics via Internet protocol to one or more users using client computer(s) such that such user(s) each can access the clinical statistics and the administrative statistics independently. Each user can access detail information by going through a hierarchy of levels of details. The user via the client computer, depending on the user's status (as approved clinicians or administrator), can also interact with the management computer to receive information as well as input information.

The present invention measures health data from a patient and relays the patient measurement data from a home health care device to a data storage and management system (center) at a site remote from the patient. For monitoring a patient, it is preferred that a measurement unit (device) resides at a place of convenience of the patient. Two data networks (at the home hub and at the data management system) are used for the transmission of the measurement data.

The present invention can be advantageously used for monitoring the health parameters of patients. It provides for simple operation that requires very little effort on the part of the patient. The present invention eases the workload of the clinician managing the patient by automating the management and review of the data. The clinicians are alerted automatically to many of the problems the patient encounters (e.g., battery failure, sudden blood pressure change, and the like). A user can easily navigate her way through the different levels of clinical and administrative information to access the desired information and statistics. The use of the public telephone system to transmit data to the data management center allows for the use of standard equipment with low cost and easy installation. Further, the data management system of the present invention allows for great flexibility in information management. By using the Internet, individuals with a variety of needs and technical expertise, over a wide geographical area can access the information to obtain the information they need, even to input their own feedback to the data management center (e.g., feedback to the clinicians). Because of the flexible nature of the routing method used in connecting computers via the Internet, the reliability of the system is increased while the cost is decreased over prior technology that uses dedicated wired connections.

### BRIEF DESCRIPTION OF THE DRAWINGS

The following figures are included to better illustrate the embodiments of the apparatus and technique of the present invention. In these figures, like numerals represent like features in the several views.

FIG. 1 is a block diagram of an embodiment of the system of the present invention.

FIG. 2 is a block diagram of an embodiment of the system of the present invention in more detail.

FIG. 3 is a block diagram of an embodiment of the system of the present invention showing multiple hubs.

FIG. 4 is an illustration showing the transmission events from a measurement unit to the home hub to the data management center in an embodiment of the present invention.

FIG. 5 is a block diagram showing how information from a patient home hub triggers a patient flag in an embodiment according to the present invention.

FIG. 6 is a block diagram showing how a user can access the patient and administration information in an embodiment according to the present invention.

FIG. 7 is a logon screen display on a client computer when logging onto the data management center in an embodiment according to the present invention.

FIG. 8 is a screen showing the flagged patients in an embodiment according to the present invention.

FIG. 9 is a screen showing a list of all patients in an embodiment according to the present invention.

FIG. 10 is a screen showing the Snapshot clinical view in an embodiment according to the present invention.

FIG. 11 is a block diagram showing how sublevels of details can be accessed in the clinical view in an embodiment according to the present invention.

FIG. 12 is a screen showing the Trends clinical view in an embodiment according to the present invention.

FIG. 13 is a block diagram showing how sublevels of details can be accessed in the Trends clinical view in an embodiment according to the present invention

FIG. 14 is a screen showing the Pt. Notes (Patient Notes) clinical view in an embodiment according to the present invention.

FIG. 15 is a block diagram showing how sublevels of details can be accessed in the Patient Notes clinical view in an embodiment according to the present invention.

FIG. 16 is a screen showing the Devices & Flags clinical view in an embodiment according to the present invention.

FIG. 17 is a block diagram showing how the sublevels of details can be accessed in the Devices & Flags clinical view in an embodiment according to the present invention.

FIG. 18 is a screen showing the Multi-Print clinical view in an embodiment according to the present invention.

FIG. 19 is a block diagram showing how the sublevels of administrative details can be accessed in an embodiment according to the present invention.

FIG. 20 is a screen showing the Clinicians administrative view in an embodiment according to the present invention.

### DETAILED DESCRIPTION OF THE INVENTION

In the present invention, a home health care device is used in a system to capture measurements on the health parameters of patients (e.g. weight, electrocardiogram (ECG), pulse, temperature, blood pressure, blood glucose level). These measurements are transmitted to a data storage and management system that is at a location outside the home. This allows a clinician at a location outside the home to view the measurement data for the management and assessment of the patient's health.

Structures

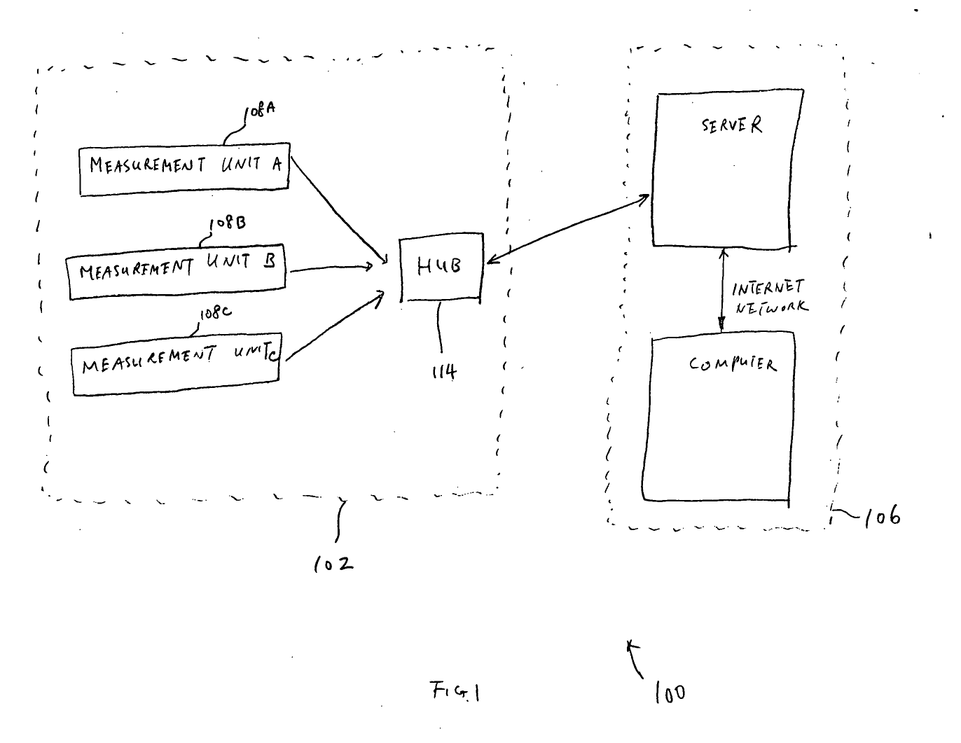

FIG. 1 depicts a block diagram showing the structures (hardware) of a system of the present invention that enables the capture of patient health data and reporting to a patient data management center. In general, the system 100 includes hardware items that are located in a nonclinical environment 102 (e.g., the patient's home in which a patient's health data are taken) and a data management center (e.g., an environment for collecting patient data such as in a hospital) 106 remote from the nonclinical environment 102. The data management center 106 manages the health data to provide access by health-care professionals.

In the nonclinical environment 102, the patient's health parameters are measured by measurement units 108A, 108B, 108C for parameters A, B, and C. As used herein “health parameters” of a patient are parameters that have bearing on the health condition of the patient and can be measured from the body of the patient (e.g., blood pressure, pulse rate, ECG, weight, temperature, blood glucose). It is to be understood that many other parameters can be measured with addition measurement units and reported to the data management center 102 if desired. Measurement equipment suitable for measuring standard health parameters are well known in the art. For example, blood pressure measurement can be done with pressure transducers and the electronics for converting the pressure data to electrical signals that can be transmitted. Temperature can be measured by temperature transducers such as thermocouples, thermistors and the like to provide electrical signals that represent the temperature data. ECG can be measured by electrodes placed on the body surface of the patient. Blood pulses can be sensed by deriving from the blood pressure measurement or by using a sound sensor to sense the sound of the heart or blood flow through restrictions. The weight of the patient can be measured by an electrical scale. It is understood that appropriate electronics will be used to associate with the sensors and transducers to provide electrical signals for transmission to the data management center.

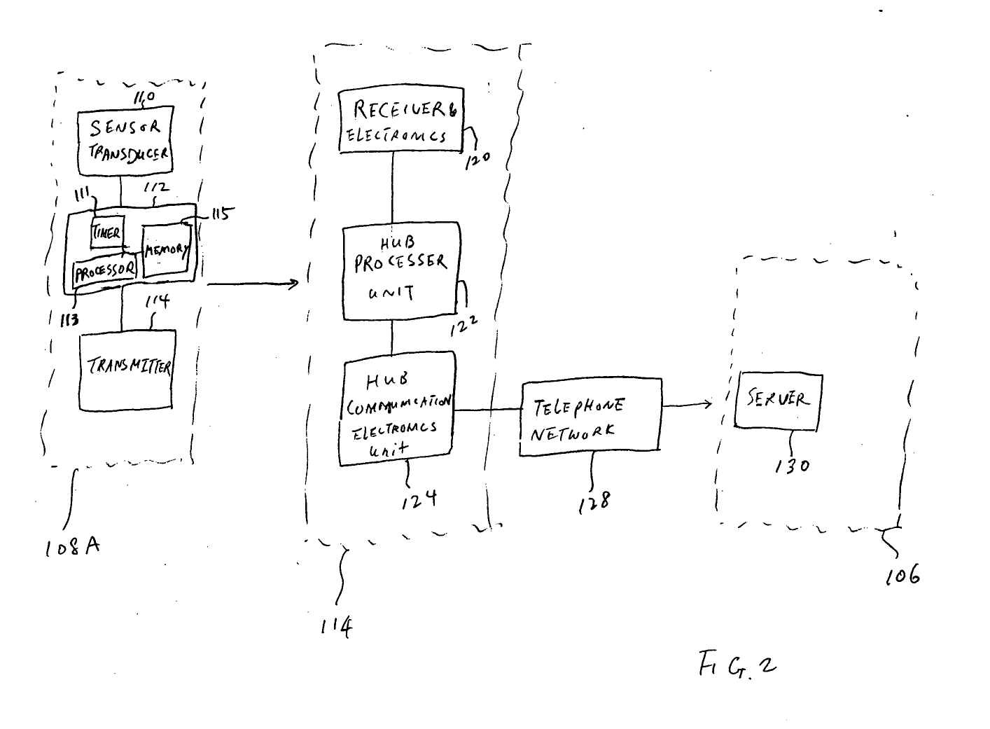

FIG. 2 illustrates a block diagram depicting an example of a measurement unit (e.g., measurement unit 108A). The sensor transducer 110 receives the physical data of the health parameter (such as blood pressure) and produces corresponding electrical signals. The measurement data being transferred from a measurement unit to the home hub have time data associated with them. The time data can be provided by a timer 111 in the measurement unit to provide time stamps corresponding to the measurement data to provide a time basis for the measurement data. Although the timing data can be based on absolute time, alternatively it can be based on relative time so that each time stamp corresponds to, for example, 15 seconds (other alternatives are e.g., 1, 5, 10, 30 seconds, etc.) of real time. As used herein, when an event is timed with a clock in terms of days, hours, minutes, seconds, etc. according to a calendar, it is considered to be timed with real time and the absolute time of the event is known. When two pieces of equipment can have communication such that an event on a first equipment can be interpreted in terms of the absolute time of the second piece of equipment, the absolute time of the event is known (i.e., can be calculated) by the second piece of equipment. A memory 115 stores the measurement and time data. The corresponding electrical signals are processed by appropriate electronic circuits 112 (,which can include a processor 113, and circuits for filtering, amplification, etc.) to be further transmitted by transmitter 114 as wireless signals. It is to be understood that associated with the measurement unit are electronics and equipment used for the collecting and processing of information, directing communication, processing information, and the like. Such electronics and equipment will be clear to one skilled in the art. For example, there may be included processor(s) used for doing calculation, communication, and controlling the sensor. Further, there are memory units (which can include RAM, ROM, hard drives, floppies and drives, CDS and drives, etc.) for storage of programs, algorithms, and data.

In a preferred embodiment, the processed signal is transmitted as radio frequency (RF) signal to a home information control gateway or hub (hereinafter “home hub” or “hub”) 114 via a RF link. (The home hub 114 and the data management center 106 will be described later.) Other wireless signals such as microwave, infrared signals can also be used. Techniques and devices (such as transmitters, receivers, signal processors) for data transmission by such mechanisms are known in the art. In one embodiment the network that allows a home health care device to send patient measurement data to home hub uses RF of 418 MHz. Another uses 900 MHz. Both are carrier-on/carrier-off (OOK, or on-off keying) receivers. It is understood that other similar means and frequencies can be used, e.g., spread spectrum technology (FSK, frequency-shift keying). Measurement generated by the transducer and the time stamps are stored to provide historical data. The historical data are transmitted in episodes of transmission so that in each episode some old data that have been transmitted before are transmitted along with new data that have never been transmitted before. Thus, data transmission is done in a scrolling fashion such that at least some of the historical data are transmitted in multiple transmission episodes in a first in first out manner as old data are replaced with new data.

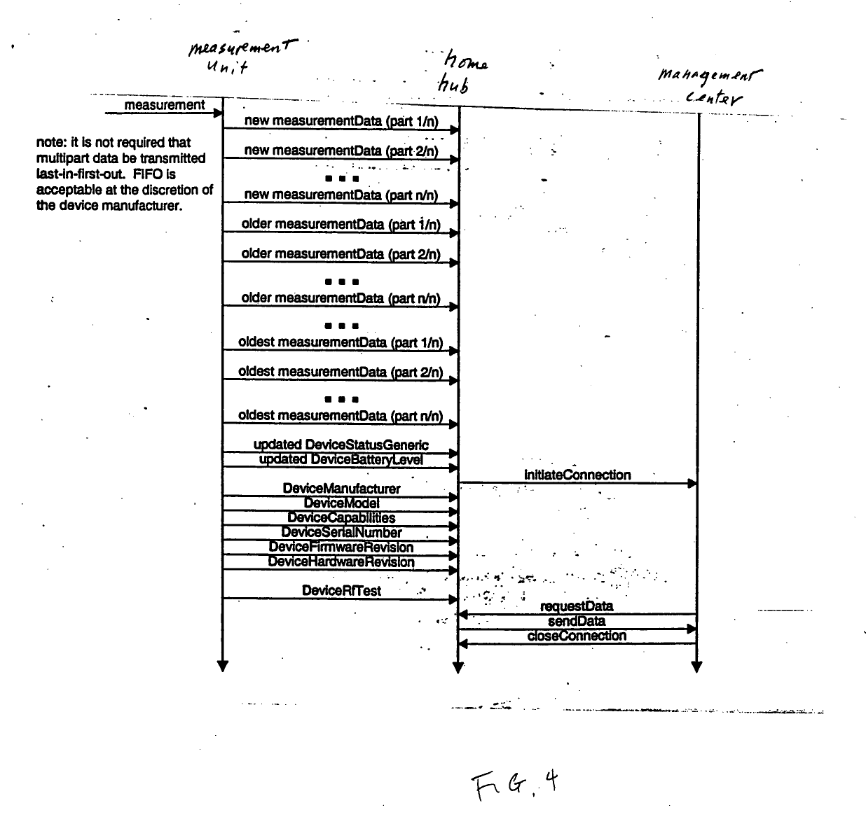

FIG. 4 shows an illustration of the transmission events from a measurement unit to the home hub to the management unit. It is noted that a measurement unit takes measurements of health parameters from the body of the user and transmits the historical data of these measurements as well as information on the measurement unit status to the home hub. The historical data include the new measurement data (shown in FIG. 4 as including parts 1/n to n/n where n are data numbers in the new measurement). The historical data also include older measurement data (relative to the other transmitted data in the particular episode of transmission). Further, the measurement unit also transmits the updated data related to events, e.g., DeviceStatusGeneric and the updated Device BatteryLevel, DeviceManufacturer, DeviceModel, DeviceCapabilities, DeviceSerialNumber, DevicefirmwareRevision, and DevoceHardwareRevision. These events and others shown in FIG. 4 are illustrative examples, the more-detailed description of which can be found in copending patent application “Home hub for patient monitoring,” invented by Cruse et al., Attorney Docket No. 10981643-1, filed on the same day as the present application, which is herein incorporated by reference in its entirety.

In more detail regarding a preferred embodiment, measurement units are designed to be simple for the patient to use. In a preferred embodiment, all of the measurement units 108A, 108B, 108C, etc., have a common display and control panel with an easy to read label identifying what they are, e.g. “Weight.” Indicators and controls on the measurement units are the same wherever possible. For example, the scale requires only that the patient stands on the scale for a few seconds and step off, the scale zeros automatically and transmits the weight without interaction from the patient. The blood pressure unit (i.e., the measurement unit that measures blood pressure) requires the patient to slide a blood pressure cuff onto his/her upper arm and then press a “Start Button.” The blood pressure unit in addition to measuring pressures can also measure pulse rate. A rhythm strip unit requires that the patient to put on “watch band” wrist electrodes or place adhesive electrodes where instructed by their clinician, and then press the Start Button. The measurement units can be made such that they will prompt the patient when the measurement is complete by sound and/or visual indication.

The measurement units 108A, 108B, 108C, etc. are placed at various locations within the nonclinical environment, e.g., home, as needed. They are designed to use little power and can be operated using line electricity or batteries. For battery-operated units, without the need to have any external connections including power cords, they can be conveniently located in the home. Furthermore, the measurement units can be designed to be resistant to liquid spills. Although measurement units can be made to make frequent measurements and accommodate a fast data transfer rate, generally for health parameters the units will function adequately with low data rates and infrequent measurements.

The measurement units can contain a resident self-test. Results of this self-test will be communicated over the RF link and through the home hub to the data management center 106. Battery operated units will check their battery status and communicate a weak battery to the data management center 106. Before the measurement units stop functioning, they will tell the patient and indicate to the clinician that batteries need replacement. When first started, the measurement units can be made to flash a LED when batteries are low.

A scale is used to measure the patient's weight. Preferably, the scale is made such that most of the functions are automatic. The patient can simply stand on the scale and the scale will turn on automatically and prompt the patient to stand still. After the patient's weight is measured, the patient is prompted to step off. Prompts can be provided by sound (voice) and LED indicator. The weight is indicated on the display on the scale, announced by voice and is automatically reported to the home hub and then to the data management center, over the patient's regular telephone line. The measurement unit can be made such that the only user control is the volume button, which adjusts the loudness of the voice. Volume level is indicated by spoken sound at each push of the button. A grab bar is supplied with each scale and can be attached to the scale's platform to help stabilize unsteady patients and to bring the sound and display closer to the patient. The weight the patient applies to the grab bar is also weighed by the scale and is included in the total patient weight reported. The weight of the grab bar itself is not included in the patient's reported weight. The scale in its zeroing step takes into account of the weight of the grab bar to render a “zero” reading before a user steps on the scale. The display unit associated with the scale for reading the weight can be mounted on the scale itself, mounted on a post that is connected to the grab bar, or be a part of the grab bar. For more accurate performance, the scale should be placed on a level, hard floor.

The measurement unit for measuring blood pressure (“Blood Pressure Unit”) is made so that it is simple to use. It includes an automatically inflatable cuff placed around the upper arm. After pressing a button (the “Start” button), the unit inflates the cuff and then automatically releases pressure as the reading is made. Blood pressure and pulse rate measurements are displayed on the numeric display panel. These measurement along with mean pressure are reported to the home hub and then to the server in the data management center, over the patient's regular telephone line. The blood pressure unit can be fitted with cuffs of different sizes (e.g., sizes for adults, youth, and children). The exhaust rate of air the blood pressure unit can be adjusted to result in the desired deflation of the cuff when the cuffs of different sizes are changed. The blood pressure unit can also be run on line voltage or batteries. Preferably, the blood pressure unit is housed in a plastic case that is easily cleaned. LCD display and a beeper can be present to prompt and guide a user through the measurement process.

A measurement unit can be used to measure the heart rhythm (“Rhythm Strip Unit”). This unit records a single lead of ECG waveform. The rhythm strip unit can include disposable electrodes for measuring ECG. In another embodiment, it can include expandable metal wristband electrodes, which can be put on the patient's wrists as directed by a clinician. The unit is preferably made for easy operation and includes a button that starts the operation and a LED display and microphone with appropriate electronics for delivering information to the patient. When the patient presses a button (the “Start” button), the unit lights its “Relax” LED and after waiting about 5 seconds, records 16 seconds of rhythm strip data. These data are reported to the home hub and then to the server, over the patient's regular telephone line. The rhythm strip unit preferably is battery-operated.

Similarly, a measurement unit for measuring the body temperature (“Temperature Unit”) of the patient can be used to detect the temperature of the patient. The temperature unit can include a probe having a temperature sensor. A button on the unit can be used to initiate the measurement after the probe has been inserted into a suitable place (e.g., the mouth of the patient). A beeper can be present to alert the patient a steady temperature measurement has been recorded by the unit.

Home Hub

The home hub 114 receives data transmissions from the measurement units, which can include a single unit or many units for reporting a variety of parameters. Measurements are reported by the home hub 114 to the data management center 106 using a telephone network, such as the public telephone system (“PTS”). Of course, dedicated telephone systems can be used if desired. FIG. 2 shows in block diagram that the home hub 114 includes a receiver (including an antenna) 120 and its associated electronic circuitry for receiving the wireless electromagnetic signal (e.g., RF signal) from the measurement unit(s) (e.g., units 108A, 108B, etc.). For example, the circuitry can include an RF module that takes the RF signals from the antenna and converts the signals into a serial byte stream. Further, A hub processor unit 122 is electronically connected to the receiver and associated electronics 120 for managing the measurement data to report to the data management center 106 by the hub communication unit 124 (including corresponding electronics). The hub communication unit 124 transmits the information (including data), as directed by the hub processor unit 122, through the telephone network 128, to the data management center 106. In addition to direct dial-in access through the public telephone network, other alternatives for the communication from the home hub 124 to the data management center 106 are practicable. Instead of a point to point telephone call, it is also possible to use the Internet for transferring the patient data. This can also make use of telephone networks. The home hub 124 would perform a dial-in to an Internet Service Provider (ISP), such as America On Line, CompuServe, and the like, rather than directly to the server at the data management center 106. At this point, one alternative would be to create a network connection, through the Internet, with the data management center 106. Another alternative is to send an email message containing the patient data through the ISP to the data management center. With either choice, encryption of patient data may be desired. These solutions differ in cost, security (interaction with firewalls and the need for encryption), and reliability of data transfer. Techniques for such direct-dial data transmission by telephone line or via an ISP from one computer to another are known in the art. Also, alternate methods of sending data from a measurement unit via the Internet to the data management center can be used. For example, one method uses a universally accessible healthcare device having a communication path and a server, wherein the healthcare device generates a set of medical information and the server provides access to the medical information using an open standard network protocol on the communication path. HTML Files may be generated on the fly by the server in the measurement unit See, e.g., U.S. Pat. No. 5,857,967 (Marcos Frid et al.), which is incorporated by reference in its entirety herein.

Although the home hub 114 can transmit data associated with absolute time to the data management, the home hub, like the measurement units, can use relative time by means of time stamps (current tick), see above. The home hub 114 can have a timer for providing relative time on events at the home hub. Memory in the home hub 114 provides for storage of data, programs and algorithms, and the like. The data management center 106 includes a computer (server) which manages and controls the flow of the measurement data information it receives from the hub 114. The features and functions of an embodiment of an applicable hub and an embodiment of an applicable data management center are described below. Although a person skilled in the art will be able to practice the present invention with the present disclosure, further details of an embodiment of an applicable home hub is described in copending patent application “Home hub for patient monitoring,” invented by Cruse et al., Attorney Docket No. 10981643-1, incorporated by reference herein, supra. Further details of an embodiment of an applicable system for patient monitoring and data management is described in copending patent application “Patient monitoring and management system,” invented by Cruse et al., Attorney Docket No. 10981642-1, filed on the same day as the present application, which is herein incorporated by reference in its entirety.

In one embodiment, the home hub 114 does not edit the measurement data but simply forwards it via a call to the data management center 106. The hub has a device address, which can be preprogrammed (e.g., when the device is made in the factory) such that the home hub can be identified by the data management center 106 among many home hubs that may be connected to the same data management center 106. The factory preprogrammed device address of the home hub is reported whenever a call is made. Although home-hubs can be made to enable two-way communication with the data management center, if desired, the home hubs can be made to only originates calls and not answer calls by the data management center.

The processor unit 122 is programmed to control the information transmission in the following manner. Since the home hub shares the patient's telephone line, it gives the patient priority use of telephone by freeing the telephone line whenever it detects a receiver is lifted or waiting to make a call if the patient is already using the line. Immediately after any new measurement is reported to it by a measurement unit (e.g., unit 108A), the home hub dials the data management center 106 if the patient's telephone is not in use. If the telephone is in use immediately after new measurements are made, the home hub waits until the line is free before initiating the call to the data management center 106. Preferably, the device is made to operate with adequate speed that a call generally last less than one minute. The home hub call is terminated if the patient picks up the receiver (the telephone becomes “off hook”, for example, when the patient wants to make a telephone call). In this case, to make a call, the patient would hang up the telephone for a second or two and then pick up the receiver again to get a dial tone. If there have been no new messages received by the home hub in the last approximately 24 hours, the home hub makes a call to the data management center 106 anyway. This tells the data management center 106 that the home hub is still in telephone communication and that the home hub has not received data recently. If the power goes down and back up, the home hub will call the data management center 106 in a few minutes after power is turned on. If a call is unsuccessful for any reason (e.g., when the data management center is busy or for any reason does not answer) the home hub retries periodically until it is successful in connecting to the data management center

The home hub is made such that it has the standard connecting features that allow for easy connection to the patient's telephone line at any convenient telephone outlet. A modem permits the transfer of information from the home hub to a computer at the data management center 106 via the telephone line. If a telephone device (e.g., telephone) is already connected, the Home hub can be connected directly to the outlet and other telephone device(s) daisy chained to the Home hub's extra RJ11 connector.

Preferably, the home hub is small to allow it to be mounted flat beside or under the telephone. It attaches to a nearby power outlet using a power module and to a modular telephone connection. The home hub preferably contains LED indicators (displays) to indicate the state of message transmission to facilitate installation and troubleshooting. For example, a green LED can show that the home hub has received data and that it is waiting to be transferred over the telephone to a server in the data management center 106 and a yellow LED shows that the home hub is using the telephone line to call the server in the data management center. A button can be placed on the home hub to aid an installer by manually causing the home hub to make a connection to the server in the data management center.

Error checking of electromagnetic wave (e.g., RF) and telephone messages ensures that valid data is communicated to the data management center 106. Along with this data, information about the state of the measurement units is also communicated, such as battery condition and the reliability of RF communications. The home hub and the measurement units check communication links even when no measurements have been recently made. This tells the clinician that the communication links are functional and that the lack of recent measurements is due to other causes.

The hub processor unit 122 in the home hub runs software that controls all of the measurement unit components. The hub processor unit 122 contains the standard components for a computer, e.g., ROM that holds the processor CPU software, RAM that provides memory used by the software, EEPROM that holds any configuration information, and the like. The hub software running on the CPU performs the major communication functions such as: read device messages received by the RF module, save measurement data, and communicate measurements data to the data management center. In typical operation, measurement data, formatted according to a predefined protocol understood by the device software, is received via the antenna and RF receiver. The measurement data are then stored in the in RAM and finally communicated over the modem to a remote data storage and management system. As data are received by the measurement unit (device), they are analyzed by the software to determine if a particular datum has been previously received. In an embodiment, information about the source of the data and time the data were acquired is used to determine if a datum is new or if it has been redundantly transmitted by another measurement unit. If the datum is new, it is stored in a queue in RAM, otherwise it is discarded to reduce the workload of the device. Measurement data are stored in RAM until they are successfully transmitted to the remote system.

After new data are stored in the queue, a telephone call is initiated to the data management center 106, which contains a remote data storage and data management system. If the call is successful, data are transmitted via the MODEM to the remote system. In an embodiment the FTP (File Transfer Protocol) is used for communication. In another embodiment a UNIX “sockets” interface can be used to allow for two-way communication between the device and the remote system. Once the data have been successfully transmitted to the remote system, they are removed from the device data queue. Identifying information about the data (source and time of measurement) are kept so that duplicate transmissions can be prevented.

Data Management Center

As already mentioned, telephone lines 128, e.g., the normal (PTS) telephone line can be used to make the connection from the home to a computer (e.g., a server for networking) 130 in the data management center 106. The same telephone line that is already installed in the patient's home can be used. The connection by the home hub 114 to the data management center 106 occurs every time a new measurement is received from a measurement unit. Under certain circumstances, the home hub will also dial the data management center 106 to provide unit status information.

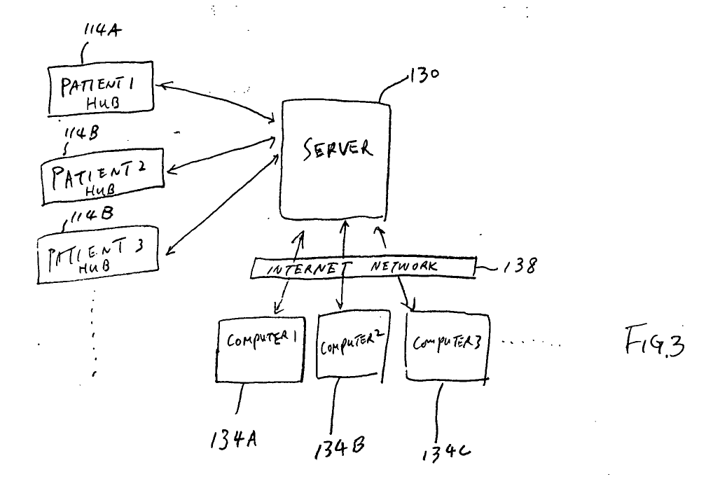

It is understood that many patients, and therefore more than one home hub, can be connected to the data management center 106. As shown in FIG. 3, the computer (server) 130 in the data management center 106 is capable of managing communication with many home hubs 114A, 114B, 114C, etc. In an embodiment, one telephone line is used for each 25 patients. Termination points should be within the proximity of the server 130. These telephone lines are dedicated to home hub communications. Preferably, a single incoming toll free telephone number is used. Local or long distance numbers can also be used. The lines are configured so that multiple home hubs can call at the same time dialing the same number. Each line is connected to a modem port installed on the server 130. After the server software is installed the new telephone number is entered into the server's configuration. Upon installation, each new home hub will obtain this number from the server 130.

The server 130 (i.e., computer in the data management center 106) is assigned an Internet Protocol IP configuration by the network administrator in order to connect to the LAN (Local Area Network) and/or the Internet. The server 130 can have its own interface (such as keyboard, pointer, display (such as monitors), sound equipment, printer, etc.) for directly interfacing with an operator. The server 130 also is set up for communicating with a plurality of computers (e.g., personal computers PC) 134A, 134B, 134C, etc., by networking, preferably via the Internet 138. It is to be understood that the server 130 will have associated with it the electronics and equipment used for the processing of information, directing communication, processing information through the Internet and other networks, and the like. This will be clear to one skilled in the art. For example, the server 130 will have processor(s) used for doing calculation, communication, and controlling other equipments. Further, there are memory units (such as RAM, ROM, hard drives, CD drives, backup tape drives, floppy drives, etc. with their respective storage medium) associated with the server 130 for short term and long term storage of programs, algorithms, and data. The programs, algorithms, and data stored in the memory units would be structured according to programing techniques, databases and data structures for effective input, execution of processes and retrieval of information. Such techniques and structures for programing, data managing and processing are known to those skilled in the art.

For the processing and communication functions, the server 130 has the necessary software and hardware components that enable such functions, e.g., server edition of MICROSOFT WINDOW NT 4.0, RAS card, backup software, firewall security software, scheduling software, utilities, etc. Further, patient management software, such as those providing tracing of health parameters, simultaneous display of multiple patients and parameters, querying, logging, and the like are also used. It is to be understood that the above examples of functions, software and hardware are given for illustrative purposed and commercially available or proprietary alternatives can be used. The server 130 also functions as part of the “intranet” system for the clinicians. Services can provide dial-in remote support and administration, subject to the customer's security policies, by means of the RAS card.

Application software that can be used in the hub-data management center system to includes a clinical client application, which runs on a user's PC (e.g., a nurse station or a patient's PC), and a clinical server application that runs on the server computer, which can also be a PC, or a minicomputer, and the like. The clinical client application is accessible and centrally distributed from the server for quick, non-disruptive installation. The clinical client application is run in the context of an industry standard web-browser, such as NETSCAPE by Netscape Corporation and INTERNET EXPLORER by Microsoft Corporation. Standard Internet protocols, e.g., TCP/IP networking protocol (Transmission Control Protocol/Internet Protocol, which is a system software that handles messages such as dividing into packets, adding information, etc.), can be used for communication through the Internet. An industry standard SQL (structured query language) database can be used to run on the server 130. It collects information from home hubs 114A, 114B, 114C, and serves information to clinical client applications. In an embodiment, with appropriate disk and telecommunication facilities, the server 130 stores a year's worth of measurements per patient and supports at least one hundred patients. It is to be understood that the server 130 of the data management center can access the information therein directly and display statistics to a user, as well as access the information via the Internet as some other client users.

The server 130 provides the data for client computers 134A, 134B, 134C for various functions. For example, one computer, e.g., computer 134A, can be operated by a clinician to monitor the day-to-day functions (even moment-to-moment functions, depending on the need) of one or more patient. The typical user is a nurse or a doctor, and is not a PC expert. The application does not require advanced computer knowledge to configure or use. A user may be allowed view or edit capability. The clinical user may be configured to see either all, or only their own patients. Accessing the data management center via LAN and/or the Internet makes the information easily available practically from anywhere in the world.

A different client computer (e.g., computer 134B) can be operated by a hospital administer to manage the insurance and clinical records. Yet another client computer may be used by the patient, or her family member, to check on the progress of the health status of the patient. To this end, the clinical application includes two modules: review and administration. The clinical review module is the primary user interface. It provides patient health-related data management (such as listing) on individual basis as well as in a group by storing and displaying data on vital signs, self-assessment notes, patient notes, demographic data, and the like. The clinical administration module is used to manage the general information of patients, such as clinician list, asset management, insurance plan list, and general organizational information and to provide status and diagnostic information for home units and clinical application software. Whereas the patient review module is used for day to day management of patients, the administration module is meant to handle less frequent changes and updates.

The daily patient review and management will normally be performed from a LAN connected client PC. Oftentimes, a patient will experience symptoms after normal working hours, so the database should also be available via dial-in. The customer's IT department can provide dial-in capability with remote LAN access (using token based authentication if they like) or they can build a VPN (Virtual Private Network, a network of computing and storage elements, their interconnects and routers, where some of the components are part of a public network, which means some part of the VPN network is not under local administrative control) with private routers or by using encrypted tunneling over the Internet.

The interaction of the server with the client computers via the Internet can be through Internet software platform such as the World Wide Web (WWW). Technique for designing and implementation of Internet interaction are known in the art. For example, web pages in the WAW can be designed with HTML (Hypertext Markup Language) and programming languages such as JAVA of Sun Microsystems Inc. can be used to make programs and applets to allows users to access and interact with the website. Various tools for programming, e.g., with HTML and JAVA, C++, and the like, are available to the public and one skilled in the art can readily device clinical applications and administrative applications, based on the present disclosure, for interacting with clients (which can be clinicians, clinic administrators, patients, relatives of patients, insurance companies, government agencies, and the like). Different levels of access to private information can be provided to different clients based on what each specific client needs to know, through the use of security measures, such as restriction to data and the use of passwords.

Clinical Application

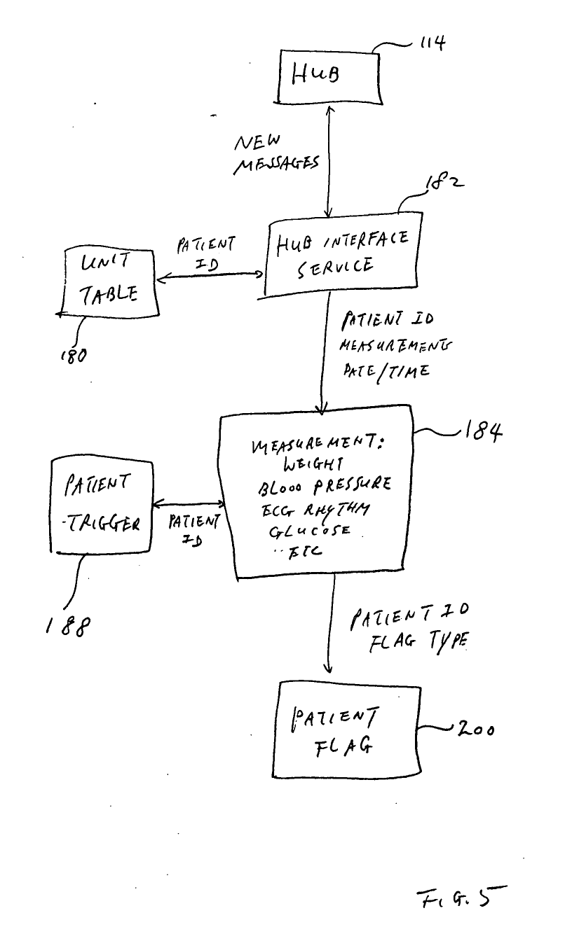

After new data have been received by the server 130 in the data management center 106, it is posted in it's database using a patient/device map. Measurement data from each unit's messages sent by the home hub 114 are stored in a measurement table as illustrated in FIG. 5. The clock associated with the server 130 (Destination clock) based on the relative time keeping of the home hubs and their corresponding measurement units, keeps reference time for the home hubs and the measurement units (herein called the ”hub interface service). The formulae for calculating the reference times are as the following:

Unit Message Time=destination receive time−hub's elapsed time (transmission time−receipt time)−unit's elapsed time (transmission time−measurement time)

Hub message time=destination receive time−hub's elapsed time (transmission time−hub message origination time). This avoids the need for extensive time synchronization between the destination's time, hub times (many hubs can be accommodated) and unit times (many measurement units can be accommodated).

The address (unique unit ID) of a measurement unit in the unit's data message is mapped to a patient ID in a unit table 180 to determine the patient associated with the data. An object model 184 provides measurement subclasses for handling data of a given type (weight, blood pressure, ECG rhythm, glucose, etc.). When data are inserted into the measurement table, this will cause an evaluation of any relevant patient trigger 188 (based on patient ID and measurement type) to see if a patient flag 200 needs to be set to bring the patient to the attention of a reviewing clinician. Flags for malfunctioning measurement units can be raised in a similar way. When data about the condition of functional (operational) parameters of a measurement unit (e.g., battery level, voltage level, current drawn, etc.) is outside a preset range, a malfunction flag on the measurement is raised. Techniques for detecting malfunction of measurement units operated by electronic functions are known in the art. Also, automatic periodic scans of the database including data from the measurement units can be performed to yield a list of measurement units that do not check in. This scan can be compared with the list of malfunctioning measurement units so as to not generate false “missed measurement.”

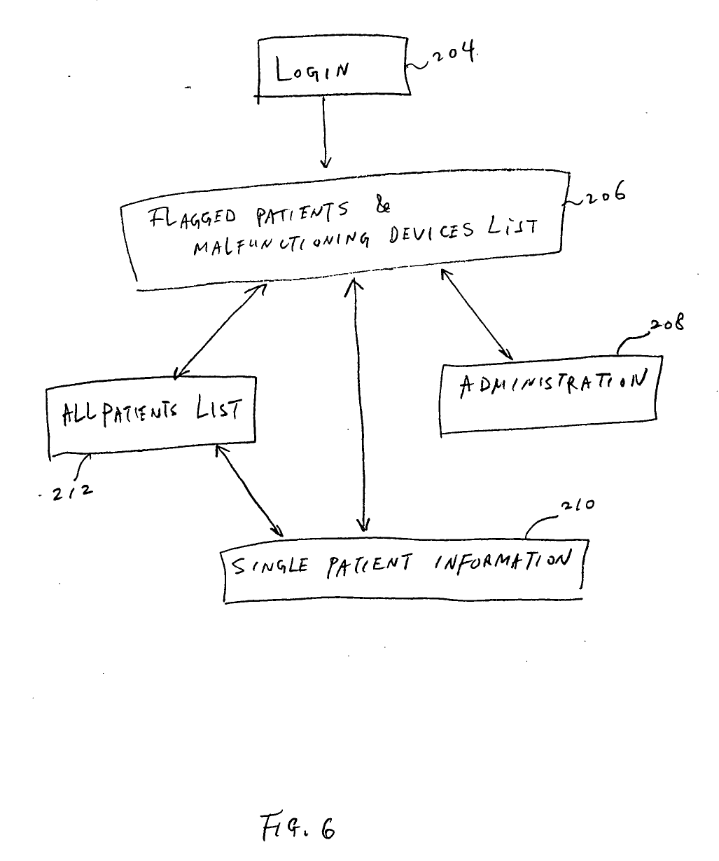

A clinical application of the present invention includes two modules: clinical review and administration. The application provides a structure that presents a hierarchy of information including various (higher to lower) levels of details. When a user accesses the server to obtain information, a high level screen is presented to the user and the user will be able to select from items of choices displayed to enter progressively lower levels to obtain more detailed information or to input data to interact with the data management center. FIG. 6 illustrates the high level navigation of the application. Clinician login (block 204) provides for secure access to patient information. A view of a list of flagged patients and a list of malfunctioning units (block 206) is presented. Then the clinician can move on to attend to administrative duties (block 208), to views for a single patient (block 210) or to views of all patients (block 212).

Login

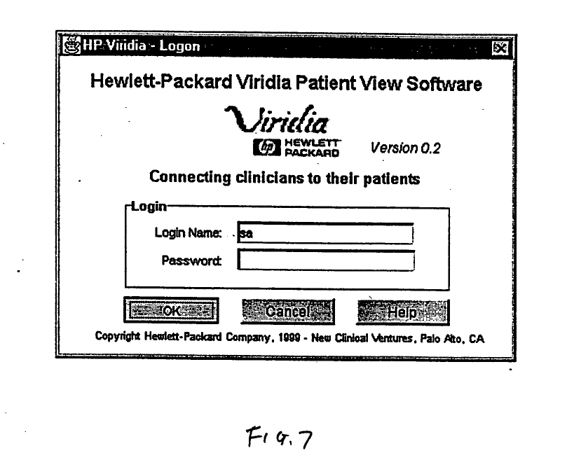

When the user (client such as a clinician) through the LAN and/or Internet connects to the site at which the patients information can be accessed (website), the login dialog box (FIG. 7) appears. This dialog box displays the name and version number of the application and allows the user to type-in her Login Name and Password associated with the viewing software (herein referred to as the “Patient View Software”). If the user clicks on the OK button, the Login Name and the Password will be accepted and authenticated. If the authentication fails, the user will be displayed a message box with an error. If the authentication succeeds, then the user will see either the Administrative screens, if she is an Administrator, or the Clinical screens if she is a clinical user. If the Cancel button is pressed, the applet will exit. The Help button will display the relevant help information.

Flagged Patients

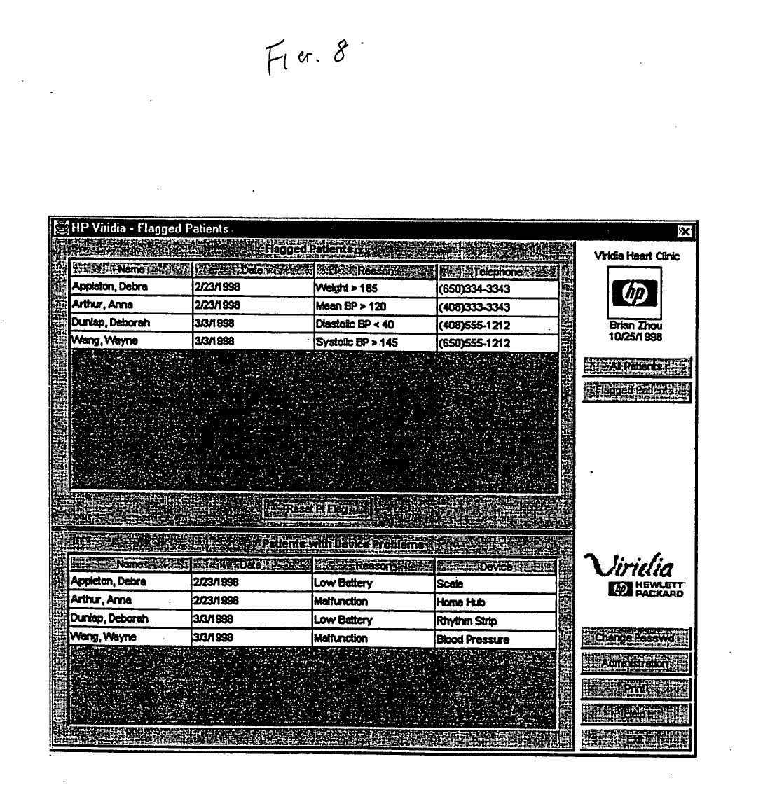

The Flagged Patients screen, as shown in FIG. 8, displays two lists: 1) The Flagged Patients list, and 2) The Patients with Device Problems list. The Flagged Patients list is a list of patients that have been flagged due to one or more reasons, the criteria of which have been preset. The table displays the Name, the Date on which the patient was flagged, the reason for the flag, and the home telephone number of the patient.

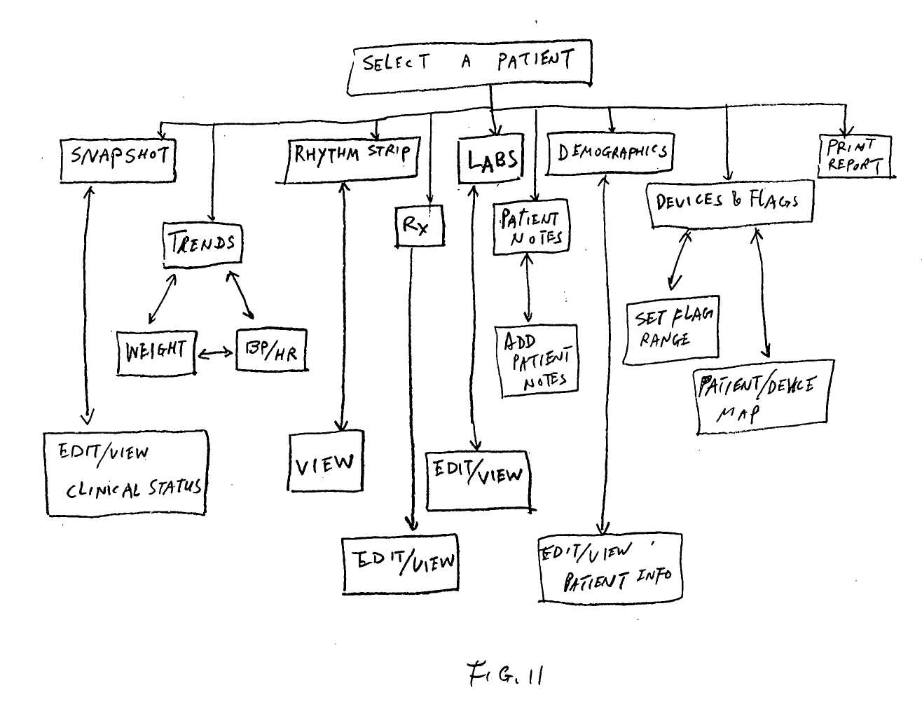

Double Clicking on any patient's row brings up the Trends Report screen (FIG. 11) of that patient. The Trend Report screen that is automatically brought up this way shows the “flagged vital measurement.” In other words, if the flag is for diastolic pressure the Trends screen will show the blood pressure; however, if the flag is for weight, the Trends screen will show the Weight Chart. In this way, the software allows a clinician to immediately see the trend of the vital signs of interest, without having to hunt for it in the computer. The Trends Report allows the user to view the vital signs (weight, blood pressure, etc.) of the patient in a graphical and tabular fashion. The buttons on the far right side panel allows the user to navigate to various other screens. The All Patients button brings up the list of all patients, including the flagged patients. The Administration button will appear only if the user has administrative privileges and will take the user to the administration screens. The Print button prints the contents of the screen. The Help button on all screens brings up the relevant help information.

The list on the lower section of the Flagged Patients list shown in FIG. 8 is a list of patients with device problems. This list displays the name of the patient, the date on which the problem was reported, the reason for the problem and the device type that reported the problem. Double clicking on any row will bring up a device information dialog box. If the device happens to be a home hub, then a hub information dialog box will appear.

All Patient

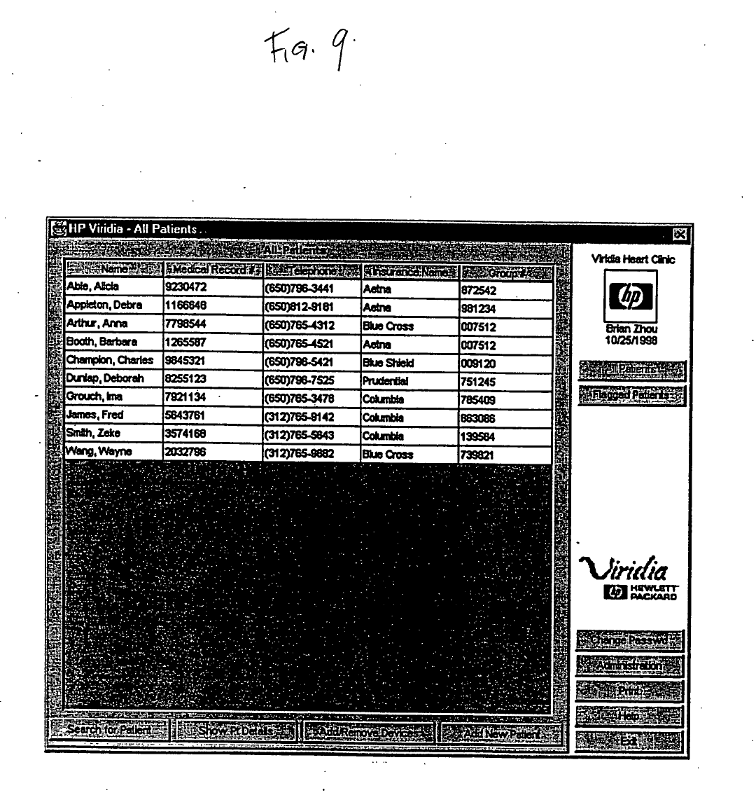

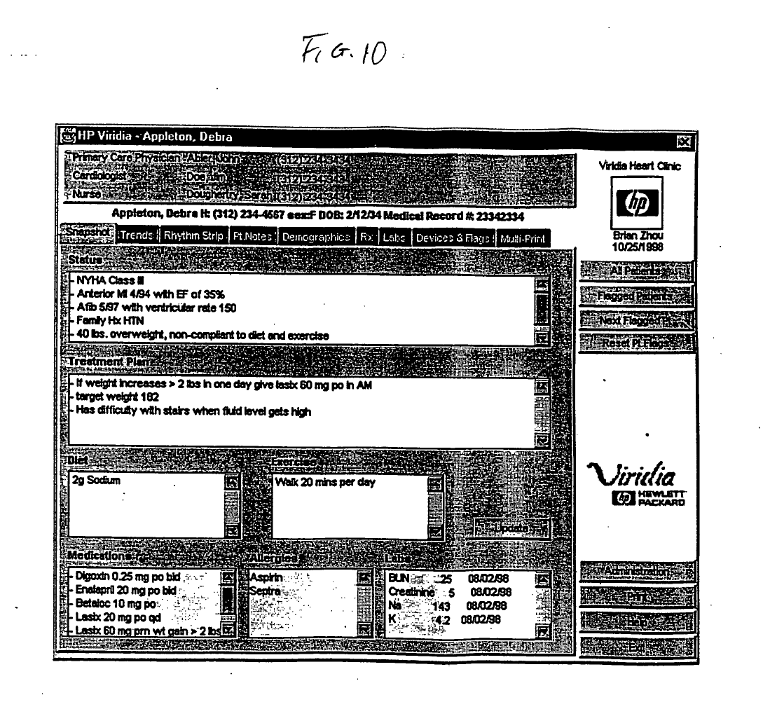

The All Patients screen (FIG. 9) displays a table with all the patients in an alphabetical order. The table contains the fields for Patient Name, Medical Record number, Home Telephone, Insurance Name, and the Group number. Double clicking on any of the patient automatically brings up the patient's medical Snapshot screen (FIG. 10). FIG. 11 shows the actions that can be taken in the clinical application, which are described in more detail below.

Snapshot Screen

When a clinical user double-clicks on a patient in the All Patients screen, the application displays the Snapshot screen (FIG. 10). The following example fields are displayed under Snapshot: the medical history, the current medication, the allergies, the most recent laboratory results, the treatment plan, the diet plan and the exercise plan. Note that the fields Status, Treatment Plan, Diet and Exercise can be changed and the database will be updated when the user clicks on the Update button. A set of tabs allows the clinician to view, edit and print the patient particulars in this example. The various tabs are Snapshot, Trends, Rhythm Strip, Pt. Notes, Demographics, Rx, Labs, Devices & Flags, and Multi-Print. The top portion of the screen displays the names and telephone numbers of the clinicians associated with the given patient. Directly above the tabs, the name and certain relevant information of the patient is also displayed for quick reference. There are several buttons on the right hand side of the screen. The All Patients button will bring up the All Patients screen. The Flagged Patients button will bring up the Flagged Patients screen. The Next Flagged Pt. button will take the user to the next flagged patient. The Reset Pt. Flags button will reset all the flags of that particular patient. A confirmation dialog box will popup to ensure that the user really does wishes to clear all the flags on the patient in the order in which they appear in the Flagged Patients screen. The Administration button will bring up the administrative portion of the application. This button will be shown only to those users who have administrative privileges. The Print button allows the user to print the screen that they are currently viewing. The Help button brings up the relevant help information for the screen and the Exit button will exit the application.

Trends Sreen

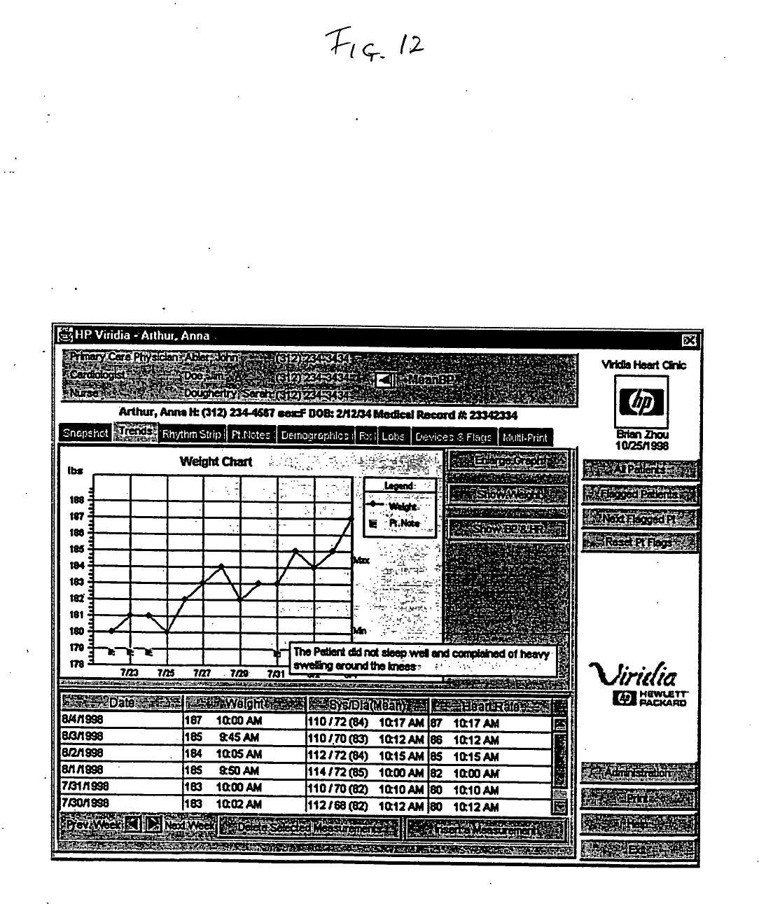

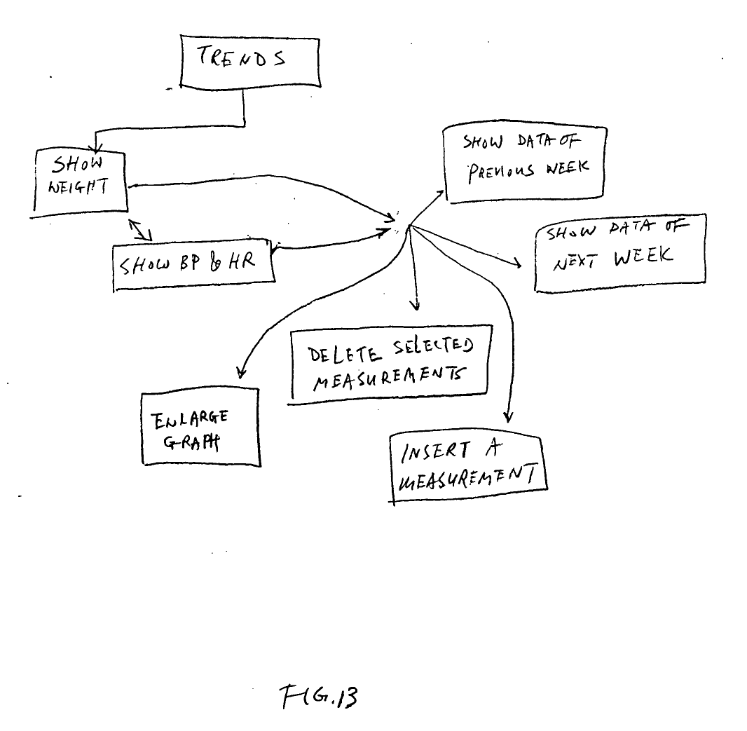

Clicking on the “Trends” button brings up the Trends screen, see FIG. 12. (Alternatively, the Trends screen can be brought up by double clicking the patient in the Flagged Patient list screen.) FIG. 13 shows the actions that can be taken from the Trends screen. The Weight chart is the default chart when the Trends screen is called up and will be displayed for the last two weeks worth of weight data. The box on top of the Trends screen also displays the flags that are tagged. The table contains two weeks worth of data. The “Show BP & PR” button will show the blood pressure chart with separate traces for systolic, diastolic and mean for the last two-weeks worth of blood pressure data. It will also show a separate trace for the pulse rate. The “Show Weight” will bring back the weight chart. In the embodiment of FIG. 9, with the right selection, the graph can display the last one-week worth of data for weight, systolic, diastolic and mean blood pressure and the pulse rate. The “Previous Week” and the “Next Week” buttons will bring up the previous and next week of data respectively. This will also change the data displayed in the graph. The user can select a particular measurement or a group of measurements in the table and click on the “Delete Selected Measurements” button to delete the selected measurements. The table is read only and no change is allowed. By moving the pointer (cursor) on the screen (using a mouse or pointer device) to point at a particular date, the corresponding patient note will appear in a box as shown in FIG. 11. The Enlarge Graph button on the Trends tab brings up a separate window. It contains the graphs of a larger size for one or more of all the measurement. The buttons at the bottom marked Prev. Week and Next Week will chart the measurements for the previous or the next week. The user can enter a measurement manually by clicking the Insert a Measurement button, which brings up a Insert Measurement dialog box (not shown in the figures). This dialog box will allow the user to manually enter the vital signs for a patient. There are Date and Time fields for validation for correctness. No future time and date will be allowed. The weight, heart rate, and blood pressure can be entered.

Rhythm Strip Screen

The Rhythm Strip screen (not shown) allows the user to see the cardiac rhythm of the patient.

Patient Notes Screen

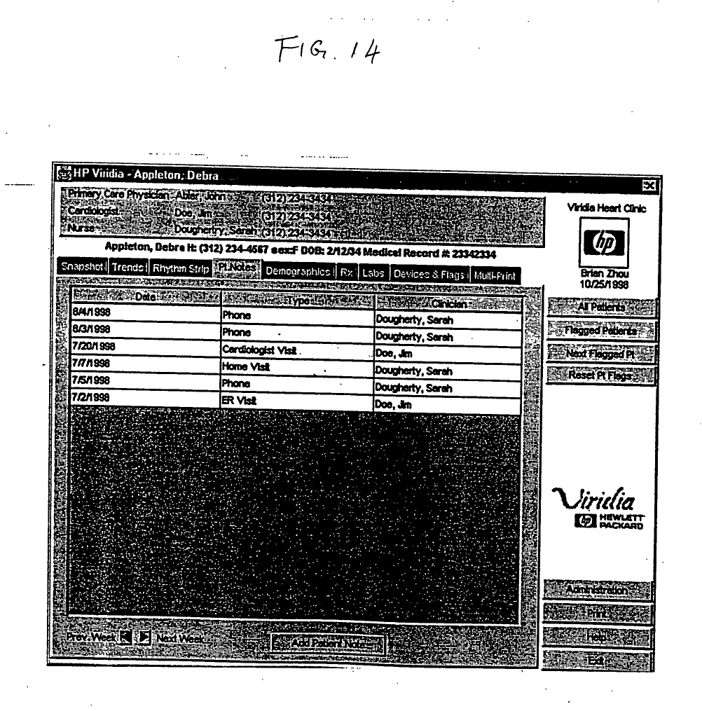

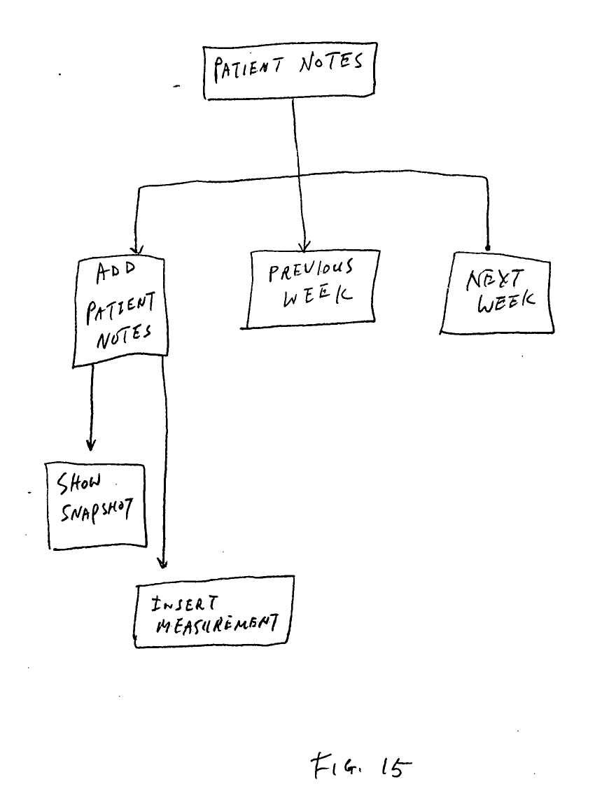

The Patient Notes screen (FIG. 14) displays the following fields: the date of contact, type of contact and the name of the clinician making the contact. FIG. 15 shows the actions that can be taken in the Patient Notes screen. Double clicking on any row of the table will take the user to the Show Patient Note dialog to display the details of a particular patient note. The Add Patient Note button will bring up the Add Patient Note dialog box to allow the user (e.g., the patient) to enter the particulars of a new contact made with the patient. The dialog box facilitates entering the information regarding the contact made by the clinician with the patient. It allows the user to select the type of contact made (e.g., by telephone, in person interview, etc.), allows the user to enter notes detailing the contact information, and provides Self-Assessment questions. The user can input the answers by activating clicking the appropriate answers. When the user presses the OK button, the dialog box will go away and this information will be entered in the database. If the user instead chooses to press Cancel, the information will be discarded and the dialog box will close. The Help button brings up the relevant help information page.

Patient Demographics Screen

The Patient Demographics screen (not shown) displays the demographics information of a patient: such as the insurance information of the patient as well as information about the Case Manager, the Cardiologist and the Primary Care Physician. The demographics of the two emergency contacts for the patient are also displayed. The lower right corner displays the list of devices that have been assigned to this patient.

Prescriptions Screen

The Rx (prescriptions) screen (not shown) displays current medications in various categories and allows updating the information. It also displays the known allergies for a particular patient. A checkbox on the far left of the screen indicates whether the patient is on that given medication or not. An At Target checkbox indicates if the ACE inhibitors are at the targeted level. The screen will display the initials of the person who last changed the medications for the patient as well as the date on which the medication was changed. Although a history of all changes is stored in the database, earlier history is not made available in the application to the day to day use by clinicians.

Labs Screen

The Labs screen (not shown) displays the most recent laboratory tests. The fields of this screen are editable and allow updates. The newly entered information will be entered into the database once the “Update” button is pressed. The screen also displays the previous value of a particular laboratory test and the date on which it was conducted. The previous values of the laboratory tests and the date on which they were performed are also shown.

Devices & Flags Screen

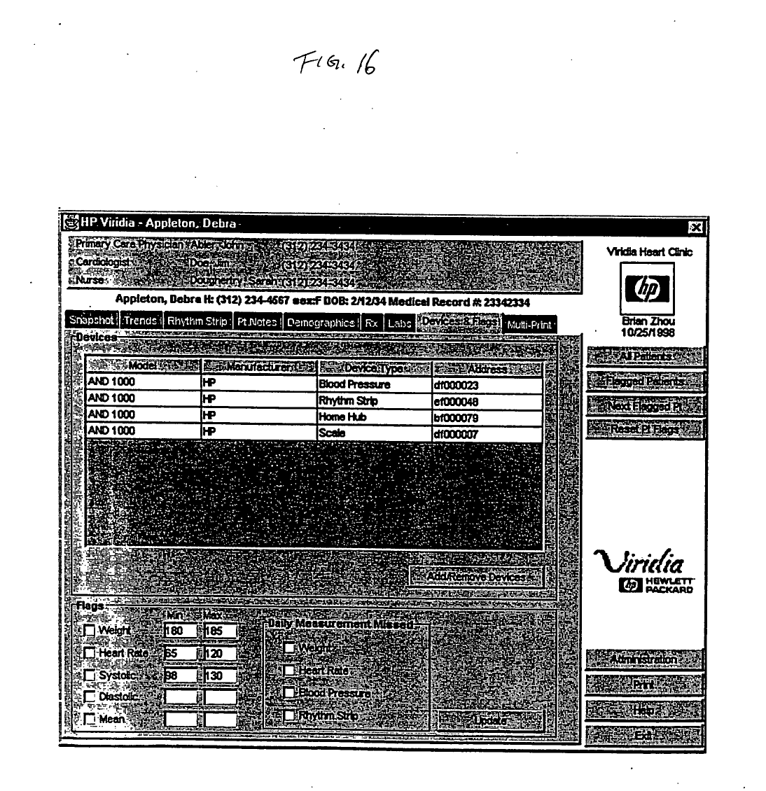

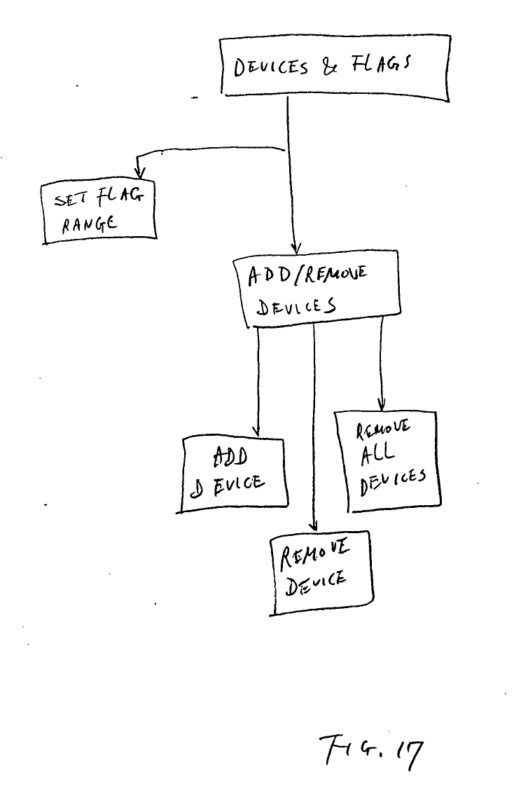

This screen (FIG. 16) displays the currently assigned devices to a patient and the flags that are set for a given patient. FIG. 17 shows that actions that can be taken in this screen. The Add/Remove Devices will take the user to the Add/Remove Devices dialog box described below. The Flags group contains the various flags that can be activated for a given patient and can be set to monitor both the upper as well as the lower range of a given vital sign. The Daily Measurement Missed flag group turns on or off the automatic Daily Measurement Missed flagging of the patient. This will allow the patient to be flagged if that particular measurement is not reported for the patient every day. The checkbox in front of each of the vital sign indicates whether the measurement should be checked for minimum or maximum limit. The Min and Max will not contain any default values when a patient is first enrolled in the system. However, the values will be stored and retained once they have been inserted. If only one value is inserted, then only that limit will be tested. For example, if only the Max Weight is entered then the incoming weight measurements will be tested for only the upper limit. The values that are entered in the Min and Max fields will be checked for validity. The range for weight is 0 to 400 lbs. The range for the blood pressure values including the heart rate is from 0 to 300. The Update button will update any modifications made to the Flags.

Multi Print Screen

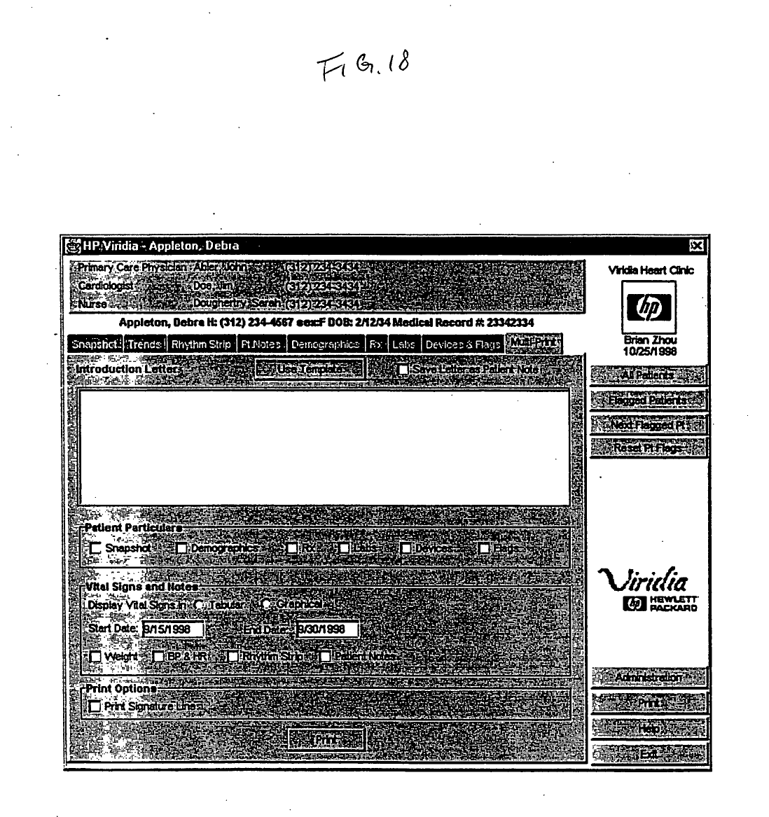

Although the print button on the side of each screen allows the user to print the screen that they are currently viewing, the Multi-Print screen (FIG. 18) will allow the user to print combinations of information from multiple screens. The Introduction Letter is a space provided for the user to write introductory note for the report to be printed. The Use Template button will allow the user to use the template for the Introduction Letter. The template can be created in the Organization Setup tab of the administrative section of the application. The Save Letter as Patient Note checkbox allows the user to save the Introduction Letter as a patient note of type: Multi-Print note. The user can select which screens to print by checking the checkbox provided with the name of each screen. The vital signs may be printed in either tabular or graphical form. The vital signs, rhythm strip and the patient notes can be printed for any given period. The Start Date and End Date fields will determine the period. The Print Signature Line will allow the user to print a signature line.

Patient Search

Clicking on the Search for Patient button in the All Patients screen (FIG. 9) will bring up the search dialog box (not shown). The user can type in the Last name of the Patient and the search dialog will scroll the All Patients list to display the patient name.

Add/Remove Devices

Clicking on the Add/Remove Devices button in the Devices & Flags screen (FIG. 16) brings up the Add/Remove Devices dialog box (not shown), which displays the currently assigned devices to the patient and also allows the user to add or remove devices. The Add Device button in the Add/Remove Devices dialog box brings up the list of available devices, which is a list of all devices that are installed and not assigned to any patient. The user selects one of the devices and clicks OK to assign that device to that patient. Using the Add/Remove Devices dialog box, devices can also be removed.

Add a New Patient

The Add a New Patient screen (not shown) is brought up by clicking the Add a New Patient button in the All Patients screen. In this Add a New Patient screen a Demographics tab is part of the patient particulars dialog box which allows the user to either add a new patient or change the patient particulars of an enrolled patient. The Demographics tab has information such as the name, address, telephone numbers, fax, pager and email address. Only numeric values will be allowed to enter in the Zip code, telephone numbers, fax and pager fields. An Other tab has patient information like medical record number, enrollment date, enrollment status, the date of birth, sex, insurance, group number, pharmacy name and pharmacy's telephone number. A Clinicians tab allows the user to select the various clinicians for a given patient. The different clinicians are the Nurse, the Cardiologist and the Primary Care Physician. Each patient may have one or more emergency contacts or alternate contacts, the Contact 1 and Contact 2 tabs.

Administration Overview

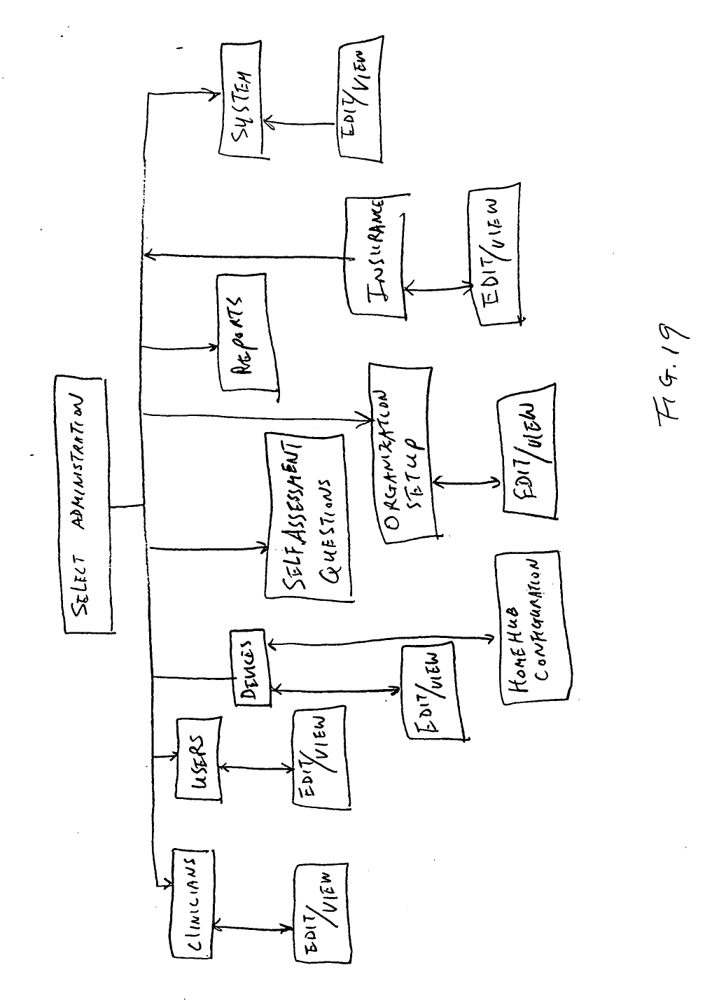

One can click the Administration button, which appears in many of screens in the clinical application, such as the Flagged Patients (FIG. 8), All Patients (FIG. 9), and the patient views (such as the Trends (FIG. 12), Snapshot (FIG. 10), etc.) to bring up the administrative view with which the clinician/administrator can perform administrative functions, see FIG. 19. Views about clinicians, users, devices, etc., can be brought up, viewed and edited. For example, one can add or remove users, add or remove clinicians, check device specific information, enter self-assessment questions, print reports, enter organization specific information, and check system log. Double-clicking the All Patients or the Flagged Patients buttons will bring up the corresponding screens of the clinical application. This administrative application can be contained within a single frame and use “tabs” to display the various sections of the application. Examples of different tabs are:

Clinicians: It displays the list of clinicians and allows the user to add or remove clinicians.

Users: It displays the list of users and allows the user to add or remove users and change login and password.

Devices: It lists all devices and if assigned, displays the name of the patient to whom it has been assigned.

Self-Assessment Questions: This is the place to enter or change the self-assessment questions.

Reports: This screen helps generate a variety of administrative reports.

Organization Setup: This tab allows the administrator to enter organization specific information like the name of the organization, its address, telephone number, the desired banner text etc.

System: This tab will allow the administrator to view system logs and check the status of critical system services.

List of Clinicians

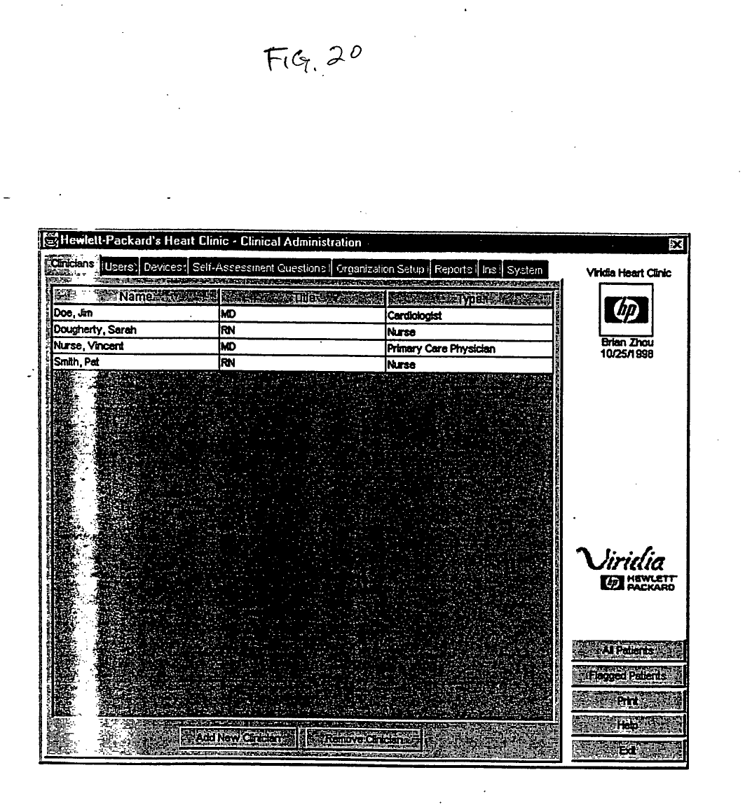

The List of Clinicians screen (FIG. 20) is the screen that is automatically brought up when the Administration button in the clinical application is double-clicked. This screen displays the list of all clinicians registered with the application. The Clinicians can include Cardiologists, Nurses, and Primary Care Physicians. The list of clinicians has the Name of the clinician, the title of the clinician and the type of clinician. The New Clinician button allows the user to add a new clinician. It brings up a New Clinician dialog box where the clinician's information can be added. The user may select a clinician and click on Remove Clinician button to remove that particular clinician or double-click on a selected clinician to bring up the Change Clinician Information dialog box to display and/or change the clinician's information. The user may double-click anywhere on the entire row instead of the Name field. When a clinician is removed, the clinician record will remain in the database and instead be marked as inactive.

The User administration tab (screen) is the place where the administrative personnel will add or remove users. This tab displays a table of users along with the login name, the full name and the title of the user. An Add New User button brings up a dialog box, which allows the user to add a new user to the list of users. The Remove User button removes the user. Double-clicking on a User row will bring up a dialog box similar to the Add New User dialog box to allow the user to modify the particulars of the user. There are two major types of user capabilities: (1) Clinician and (2) Administrator. Alternatively, a third, or even more types of users can be included, such as the patient, relatives of the patient, insurance company, etc. Each type of users is allowed access with security measures to only the appropriate type of information to maintain privacy of the patients and security of the system. A user may have one or both of these capabilities. Each type of user can be made a Read Only user. A read only user may access information but will not be able to change any information. If a user is a clinical user and has read/write access to patient information, the user needs to be associated to an approved clinician so that any patient information changed by that user can be attached to that clinician. Due to this reason, this clinician has to be first added to the application as a new clinician before adding him/her as a user. A Clinical user with read only capability does not have to be added as a clinician. A Clinical user may have the capability to see all of the patients within the organization or only his/her own patients

Device Administration

The Device Administration tab displays a table of devices of a particular type and the name of the patient to whom it has been assigned, in alphabetical order by patient name. The device list contains the last transmission time as a column in the table. This allows the administration personnel to verify the general device activity. Double clicking on any row of the device list table, brings up the device information dialog box with the information for that particular device. Double clicking on any row of the device list table brings up the device (unit) information dialog box with the information for that particular device. If that device happens to be a home hub, then the Home Hub information dialog box comes up. The hub configuration dialog box can be brought up by clicking on the Hub Configuration button on the Devices tab. Here, the administrator can enter the telephone numbers that the Home Hub will dial. It will try to dial the numbers in the order in which they appear in the list.

Self-Assessment Questions

The Self-assessment Questions tab is used when a clinician makes contact with a patient and creates a new patient note. The patient is asked these self-assessment questions and the answers are logged with the patient note in this example. This tab allows the administrative personnel to activate and insert self-assessment questions. The checkboxs each activates a particular question.

Organization

The Organization Setup tab is part of the Clinical Administration screens in this example. This tab allows the user to insert various organization-related information. For example, the name of the organization, the desired banner to display on the screens, its address, telephone number, fax number, etc. A large area titled Introduction Letter Template for Multi-Print is for use as a template for all users when printing a report from the Multi-Print tab in the Clinical screens. After new data are keyed in, the update button is clicked to enter into the database.

Insurance

This tab in the Administration view lists the insurance companies available to pick for a patient. In order to associate an insurance company with a patient, the insurance company has to be first inserted in the list. In this tab, clicking an Add New Insurance button brings up a dialog box that accepts the name of an insurance company. Double clicking a Remove Insurance button will bring up a dialog box to remove the name of an insurance company from the list.

System

The System tab in the Administrative view is for use by an information technology (IT) personnel or a service personnel who is intimately familiar with the application internals. This tab has two sections: System Logs and Services. The System Logs button leads to displaying the logs that are stored on the system server. The user will need to type-in the date for which the system logs are desired and then click on the Show Logs button. The application will then fetch the system logs for that date and display them in a tabular manner, including time stamps, Priority, Error Code, and Message. The Services group displays the status of the two key services within the system, namely the Hub-Interface and the Proxy Server. When the user clicks on the Refresh button, the status of the services will be displayed.

By using the clinical application and the administrative application, clients (including e.g., clinicians, administrators, patients and relatives, etc.) are able to access and/or input information into the server in the data management center. One further application of the present invention is to include a disease module for diagnosis to help the clinician in diagnosing diseases based on the data received from the patients. Certain techniques for programing a disease module and the use of thereof are known in the art, e.g., U.S. Pat. No. 5,404,292 (Hendrickson), which is incorporated by reference in its entirety herein.

Due to the format of presentation of information in the present invention, a client will be able to utilize the information efficiently. Each particular client is allowed access to read and/or input the appropriate type of information pertinent to the client. By selectively introducing ranges on preselected parameters (e.g., blood pressure), clients can be alerted on patients that have activities outside preset ranges (e.g., the patient can be flagged). Although the preferred embodiment of the present invention has been described and illustrated in detail, it is to be understood that a person skilled in the art can make modifications within the scope of the invention, especially in numerical values relating to size, shapes, frequencies, and the like. It is also understood that given the functionality descriptions presented in this disclosure, a person skilled in the art will be able to construct computer programs and algorithms to control equipment and communicate information in accordance with the functionality described herein.

1. A method providing users access to information of health parameters on patients, comprising:
(a) receiving digital data from one or more patient sources on the health parameters of the patients;
(b) processing the digital data using a computer and providing clinical statistics and administrative statistics; and
(c) providing access to the clinical statistics and administrative statistics via Internet protocol to one or more users such that the one or more users can each access the clinical statistics and the administrative statistics independently.

2. A method according to claim 1, further comprising providing access to the clinical statistics and administrative statistics via hierarchal screens of higher and lower levels wherein a user can access lower levels by selecting from the higher levels to enter the lower levels.

3. A method according to claim 1, wherein the digital data from the patient sources have data on a relative time scale and the method further comprises computing the absolute time of events in the digital data from the patient sources based on the data on relative time of the events.

4. A method according to claim 3, wherein the digital data from the patient source contains data of a relative time scale on the patient source and a relative time scale on a health parameter sensing unit and the method further comprises computing the absolute time of events in the digital data from the patient sources using the relative time scales.

5. A method according to claim 3, further comprising receiving digital data from a plurality of patient sources each of which receiving data from a plurality of health parameter sensing units, wherein the digital data from each patient source contain data of a relative time scale on the patient source and a relative time scale on each health parameter sensing unit and the method further comprises computing the absolute time of events in the digital data from the plurality of patient sources using the relative time scales.

6. A method according to claim 1, further comprising processing statistics from a plurality of patient sources and compiling a flagged list of patients each having at least one health parameter outside a preset range and presenting the flagged list for review by a clinician computer accessing the clinical statistics.

7. A method according to claim 6, further comprising showing a flagged list of patients having a health parameter sensing unit with a functional parameter outside a preset range simultaneously with the flagged list of patients having at least one health parameter outside a preset range.

8. A method according to claim 6, further comprising updating statistics automatically as new data are received from the patient sources.

9. A method according to claim 6, further comprising presenting a list of clinical information when a user selects a patient from the flagged list such that the user can select from the list of clinical information to access statistics thereof.

10. A method according to claim 9, further comprising presenting trends statistics on historical data of a health parameter in the list of clinical information.

11. A method according to claim 9, further comprising simultaneously presenting trends statistics on historical data of a health parameter in the list of clinical information and presenting patient notes.

12. A method according to claim 9, further comprising presenting statistics on devices and flags of health parameters in the list of clinical information.

13. A method according to claim 12, further comprising allowing access to a plurality of users to different statistics with different limitations of access.

14. A system for providing users access to information of health parameters on patients, comprising:
(a) modem for receiving digital data from one or more patient sources on the health parameters of the patients; and
(b) management computer for processing the digital data and providing clinical statistics and administrative statistics and for providing access to the clinical statistics and administrative statistics via Internet protocol to one or more users such that the one or more users can each access the clinical statistics and the administrative statistics independently.

15. A system according to claim 14, wherein the digital data from the patient sources have data on a relative time scale and the system includes a timer associated with the management computer to provide absolute time for computing absolute time of the digital data from the patient sources based on the data on relative time of the digital data.

16. A system according to claim 14, wherein the digital data from the patient source contains data of a relative time scale on the patient source and a relative time scale on a health parameter sensing unit and the system includes a timer associated with the management computer to provide absolute time for computing absolute time of digital data associated with the patient source and the health parameter sensing unit using the relative time scales.

17. A system according to claim 14, further comprising memory associated with the management computer for storing statistics for access by users.

18. A system according to claim 14, further comprising means for processing statistics from a plurality of patient sources and compiling a flagged list of patients each having at least one health parameter outside a preset range and present the flagged list to a user accessing the clinical statistics via a clinician computer.

19. A system according to claim 14, further comprising means for processing statistics from a plurality of patient sources and compiling a flagged list of patients each having at least one health parameter outside a preset range and compiling a flagged list of patients each having at least one malfunctioning device which is used for measuring health parameter to present the flagged lists to a user accessing the clinical statistics via a clinician computer.

20. A system according to claim 14, further comprising means for arranging the clinical statistics and administrative statistics into hierarchal screens of higher and lower levels wherein a user can access information in the lower levels by selecting from the higher levels to enter the lower levels.

21. (canceled)

22. (canceled)

23. (canceled)

24. (canceled)

25. (canceled)

26. (canceled)

27. (canceled)

28. (canceled)
